(19) United States
(12) Patent Application Publication
(10) Pub. No.: US 2019/0180422 A1
(43) Pub. Date: Jun. 13, 2019

(54) METHOD AND APPARATUS FOR PERFORMING GEOMETRIC CORRECTION ON IMAGES OBTAINED BY MULTIPLE CAMERAS

(71) Applicant: Electronics and Telecommunications Research Institute, Daejeon (KR)

(72) Inventors: Chang Woo CHU, Daejeon (KR); Kyung Kyu KANG, Daejeon (KR); Hye Sun KIM, Daejeon (KR); Chang Joon PARK, Daejeon (KR); Yun Ji BAN, Daejeon (KR); Dong Wan RYOO, Daejeon (KR); Jung Jae YU, Daejeon (KR); Man Hee LEE, Daejeon (KR)

(73) Assignee: Electronics and Telecommunications Research Institute, Daejeon (KR)

(21) Appl. No.: 16/209,577

(22) Filed: Dec. 4, 2018

(30) Foreign Application Priority Data
Dec. 7, 2017 (KR) 10-2017-0167846

(51) Int. Cl. G06T 5/00; G06T 7/73; G06T 5/50; H04N 5/247

(52) U.S. Cl. CPC G06T 5/006; H04N 5/247; G06T 5/50; G06T 7/74

(57) ABSTRACT

Disclosed is a method of performing geometric correction on images obtained by multiple cameras and an image obtainment apparatus therefor, the method including: receiving the images obtained by the multiple cameras; extracting feature points of the received images and checking an interrelation between the extracted feature points; estimating locations and directions of the cameras, which respectively obtain the images, by using the interrelation between the feature points; calculating a relative geometric relationship between the multiple cameras from the estimated locations and directions of the cameras when the received images are determined as the images obtained by the multiple cameras with a fixed geometric interrelationship; and performing the geometric correction on each of the images by using the calculated geometric relationship. The method of efficiently performing geometric correction according to the embodiment of the present invention enables images to be obtained easily using the unmanned device with a short photographing time.

### CROSS REFERENCE TO RELATED APPLICATION

The present application claims priority to Korean Patent Application No. 10-2017-0167846, filed Dec. 7, 2017, the entire contents of which is incorporated herein for all purposes by this reference.

### BACKGROUND OF THE INVENTION

### Field of the Invention

The present invention relates generally to a method of performing geometric correction on images obtained by multiple cameras and an image obtainment apparatus therefor. More particularly, the present invention relates to a method of performing geometric correction on images obtained by image obtaining equipment using multiple cameras with fixed relative geometric relationship and a camera with free motion together and an image obtainment apparatus therefor.

### Description of the Related Art

Recently, as a technology of a small unmanned aerial vehicle develops, interest in a drone (an unmanned device, an unmanned aerial vehicle, or an unmanned aerial device, hereinafter, referred to as “an unmanned device”) has increased. The unmanned device is widely used in personal image capturing as well as in broadcasting and filmmaking. Also, in 3D mapping or 3D reconstruction fields, the drone is a trendy device for capturing an image, which replaces expensive aerial image acquisition equipment. Recently, in the virtual reality field, the drone is used as aerial panoramic image obtainment equipment.

In the meantime, in order to obtain and reconstruct a three-dimensional image, a rig capable of being equipped with several cameras is manufactured and installed on the unmanned device to photograph a reconstruction target in different directions. Also, the image is obtained by a system for an unmanned device when the unmanned device is in flight. Therefore, when the several cameras are fixed on the rig and photographing is performed at the same time, it is determined that an interrelationship between the cameras is fixed. For example, even though the cameras are provided on the same rig, when the cameras are out of sync, the images obtained during flight are classified as images obtained by a camera with free motion.

In the meantime, in order to correct geometric distortion that occurs in images obtained by remote sensing of an aircraft, a satellite, or the like, an image processing process to which geometric correction is applied is involved. That is, the object at the ground surface in the image obtained by a device for taking an image does not match the location indicated on the map, so that this results in errors in the positioning of the photographing device at the time of photographing, the curvature of the earth, rotation of the earth, and the observation device. These errors are corrected by finding the cause of the distortion and performing projection in reverse or by correlating a ground reference point with the location of the image corresponding to the ground reference point and constructing an relational expression, which is called geometric correction.

However, conventionally, the unmanned device equipped with multiple cameras sets the geometric interrelationship between the multiple cameras only by a physical method, so that a large amount of calculation is required in geometric correction. Therefore, degradation of battery efficiency due to a large amount of computation causes the photographing time to be shortened, which is the reason that the overall performance of the unmanned device and the system for the unmanned device is degraded.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose a method and apparatus for performing efficient geometric correction in a system for an unmanned device using multiple cameras.

Also, the present invention is intended to propose a new method of performing geometric correction, the method significantly reducing the amount of calculation in geometric correction by calculating and estimating a relative geometric interrelationship between multiple cameras using the images obtained by the multiple cameras.

Also, the present invention is intended to propose an image obtainment apparatus for performing efficient geometric correction by receiving taken images from an unmanned device and by calculating and estimating a relative geometric interrelationship between multiple cameras.

Other objects and advantages of the present invention will be understood from the following descriptions and become apparent by the embodiments of the present invention. In addition, it is understood that the objects and advantages of the present invention may be implemented by components defined in the appended claims or their combinations.

In order to achieve the above object, according to one aspect of the present invention, there is provided a method of performing geometric correction on images obtained by multiple cameras, the method including: receiving, at an image reception step, the images obtained by the multiple cameras; extracting, at an image feature point extraction step, feature points of the received images and checking an interrelation between the extracted feature points; estimating, at a location and direction estimation step, locations and directions of the cameras, which respectively obtain the images, by using the interrelation between the feature points; calculating relative geometric relationship between the multiple cameras from the estimated locations and directions of the cameras when the received images are determined as the images obtained by the multiple cameras with a fixed geometric interrelationship; and performing the geometric correction on each of the images by using the calculated geometric relationship.

Also, the method may further include performing, when the received images are determined as images obtained by a camera with free motion rather than the multiple cameras with the fixed geometric interrelationship, the geometric correction on each of the images by applying the estimated locations and directions of the camera with free motion.

Also, the performing of the geometric correction on the images obtained by the multiple cameras with the fixed geometric interrelationship may be simultaneous with the performing of the geometric correction on the images obtained by the camera with free motion rather than the multiple cameras with the fixed geometric interrelationship.

Also, the method may further include initializing, at a geometric correction initialization step, the geometric correction by using the interrelation between the feature points.

Also, at the geometric correction initialization step, an essential matrix between the images may be decomposed from initial frame images and relative positioning and location values may be obtained.

Also, at the image reception step, the images may be received using one among short-range wireless communication means, wired/wireless data communication means, and direct copying from each camera.

Also, the image reception step may include classifying the images obtained by the cameras with the fixed geometric interrelationship by using meta information on the images.

Also, the image reception step may further include: determining, when the images are classified as the images obtained by the cameras with the fixed geometric interrelationship, the image obtained by one camera of the multiple cameras as a reference image for each photographing time and determining the image obtained by another camera of the multiple cameras as a comparison image obtained at the same time as the reference image.

Also, at the performing of the geometric correction simultaneously, simultaneous optimization may be performed considering the geometric interrelationship between the cameras, a camera group, and the locations and directions of the camera with free motion.

Also, at the calculating of the geometric interrelationship between the cameras, the geometric interrelationship between the cameras at a photographing time may be estimated from the obtained images.

According to another aspect of the present invention, there is provided an image obtainment apparatus for performing geometric correction on images obtained by multiple cameras, the apparatus including: an image input unit receiving the images obtained by the cameras; an image feature point extraction unit extracting feature points of the received images and checking an interrelation between the extracted feature points; a geometric relationship determination unit estimating locations and directions of the cameras, which respectively obtain the images, by using the interrelation between the feature points, the geometric relationship determination unit calculating relative geometric relationship between the from multiple cameras the estimated locations and directions of the cameras when the received images are determined as the images obtained by the multiple cameras with a fixed geometric interrelationship; and a geometric correction processing unit performing the geometric correction on each image by using the calculated geometric relationship.

Also, the apparatus may further include a display unit visually displaying an image that will be or has been subjected to the geometric correction.

Also, the apparatus may further include a communication unit communicating with the camera or an external device.

Also, the geometric correction processing unit may perform, when the received images are determined as images obtained by a camera with free motion rather than the multiple cameras with the fixed geometric interrelationship, the geometric correction on each of the images by applying the estimated locations and directions of the camera with free motion.

Also, the geometric correction processing unit may simultaneously process performing of the geometric correction on the images obtained by the multiple cameras with the fixed geometric interrelationship and performing of the geometric correction on the images obtained by the camera with free motion rather than the multiple cameras with the fixed geometric interrelationship.

Also, the image feature point extraction unit may initialize the geometric correction by using the interrelation between the feature points.

Also, the image input unit may classify the images obtained by the cameras with the fixed geometric interrelationship by using meta information on the images.

Also, the image input unit may determine, when the images are classified as the images obtained by the cameras with the fixed geometric interrelationship, the image obtained by one camera of the multiple cameras as a reference image for each photographing time and may determine the image obtained by another camera of the multiple cameras as a comparison image obtained at the same time as the reference image.

Also, the geometric correction processing unit may perform simultaneously optimization considering the geometric interrelationship between the cameras, a camera group, and the locations and directions of the camera with free motion, in simultaneously processing the performing of the geometric correction.

Also, the geometric relationship determination unit may estimate the geometric interrelationship between the cameras at a photographing time from the obtained images.

According to the embodiments of the present invention, effects as follows are obtained. First, through the method of efficiently performing geometric correction, it is easy to obtain images using the unmanned device with a short photographing time. Second, for example, all images obtained by the multiple cameras with the fixed geometric interrelationship and by the independent camera with free motion are used to obtain and reconstruct a three-dimensional image, so that usage of the system for the unmanned device is enhanced. Also, for example, the system for the unmanned device to obtain and reconstruct the three-dimensional image, restrictions on photographing synchronization between cameras are relaxed.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a diagram illustrating an example of an unmanned device rig equipped with multiple cameras involved in the present invention;

FIG. 2 is a diagram illustrating an example of trigger signals applied to an unmanned device equipped with multiple cameras involved in the present invention;

FIG. 3 is a diagram illustrating an example of a system for a multi-camera unmanned device involved in the present invention;

FIG. 4 is a diagram illustrating an example of an image obtainment apparatus for performing geometric correction according to the present invention;

FIG. 5 is a flowchart illustrating a method of performing geometric correction according to an embodiment of the present invention;

FIG. 6 is a flowchart illustrating a method of performing geometric correction according to another embodiment of the present invention; and

FIG. 7 is a flowchart illustrating a method of performing geometric correction according to still another embodiment of the present invention.

### DETAILED DESCRIPTION OF THE INVENTION

Hereinbelow, exemplary embodiments of the present invention will be described in detail with reference to the accompanying drawings such that the invention can be easily embodied by those skilled in the art to which this invention belongs. However, the present invention may be embodied in various different forms and should not be limited to the embodiments set forth herein.

In describing embodiments of the present invention, it is noted that when the detailed description or known configurations or functions related to the present invention may make the gist of the present invention unclear, the detailed description of thereof will be omitted. Also, portions that are not related to the present invention are omitted in the drawings, and like reference numerals designate like elements.

In the present invention, elements that are distinguished from each other to clearly describe each feature do not necessarily denote that the elements are separated. That is, a plurality of elements may be integrated into one hardware or software unit, or one element may be distributed into a plurality of hardware or software units. Accordingly, even if not mentioned, the integrated or distributed embodiments are included in the scope of the present invention.

In the present invention, elements described in various embodiments do not denote essential elements, and some of the elements may be optional. Accordingly, an embodiment that includes a subset of elements described in another embodiment is included in the scope of the present invention. Also, an embodiment that includes the elements which are described in the various embodiments and additional other elements is included in the scope of the present invention.

Hereinafter, the embodiments of the present invention will be described with reference to the accompanying drawings.

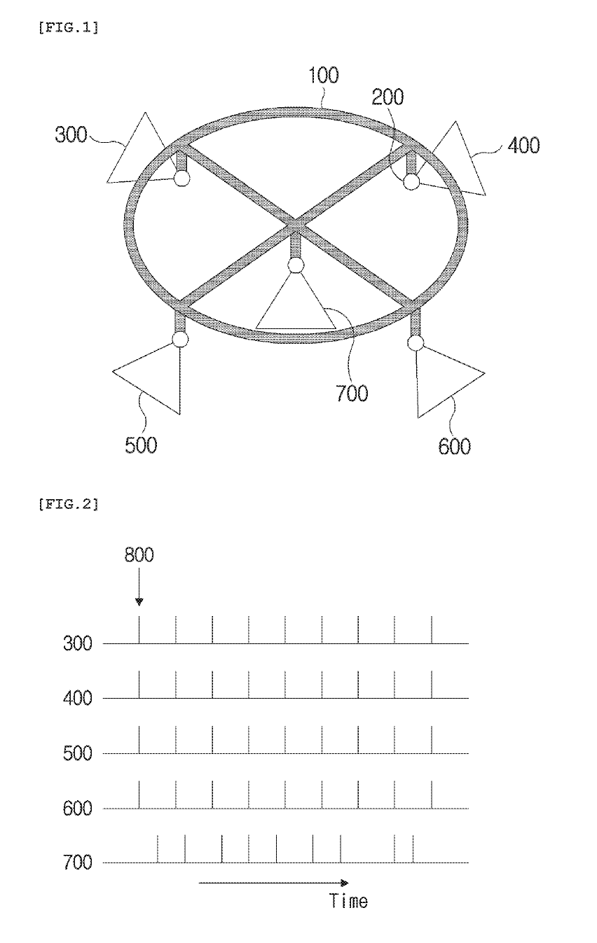

FIG. 1 is a diagram illustrating an example of an unmanned device rig 100 equipped with multiple cameras involved in the present invention. FIG. 2 is a diagram illustrating an example of trigger signals applied to an unmanned device equipped with multiple cameras involved in the present invention.

In order to equip the unmanned device with multiple cameras, generally, a rig is used conventionally. Referring to FIG. 1, a single rig 100 is equipped with multiple cameras 300 to 700. Also, regarding the rig 100, the rig is equipped with the cameras and further includes an assembly unit 200 capable of adjusting the location and the positioning direction of the camera. The rig 100 may use a gimbal to remain horizontally even, when equipping the unmanned device with the rig. Also, in FIG. 1, as an example, illustrated is that five multiple cameras 300 to 700 are provided, but the number of cameras may vary according to a system.

In this regard, the multiple cameras 300 to 700 provided on the rig 100 may be classified as cameras with a fixed geometric interrelationship and an independent camera with free motion.

That is, as shown in FIG. 2, regarding the trigger signal applied to each of the cameras 300 to 700, when the same trigger signal 800 is applied to the cameras 300 to 600, the cameras are regarded as cameras 300, 400, 500, and 600 with a fixed relative geometric interrelationship. Conversely, when a trigger signal different than the cameras 300 to 600 is applied to the camera 700, the camera 700 is regarded as the camera 700 with free motion. In this regard, FIG. 1 illustrates, for example, four cameras 300 to 600 with the fixed geometric interrelationship and one camera 700 with free motion, but the number of cameras and the location are not limited thereto.

Also, FIG. 1 illustrates, for example, the case in which all the cameras 300 to 600 with the fixed geometric interrelationship and the camera 700 with free motion are provided on the same rig 100. However, it is possible that only the cameras 300 to 600 with the fixed geometric interrelationship are provided on the same rig 100 and the camera 700 with free motion is provided at another location, for example, another unmanned device rig or the ground space.

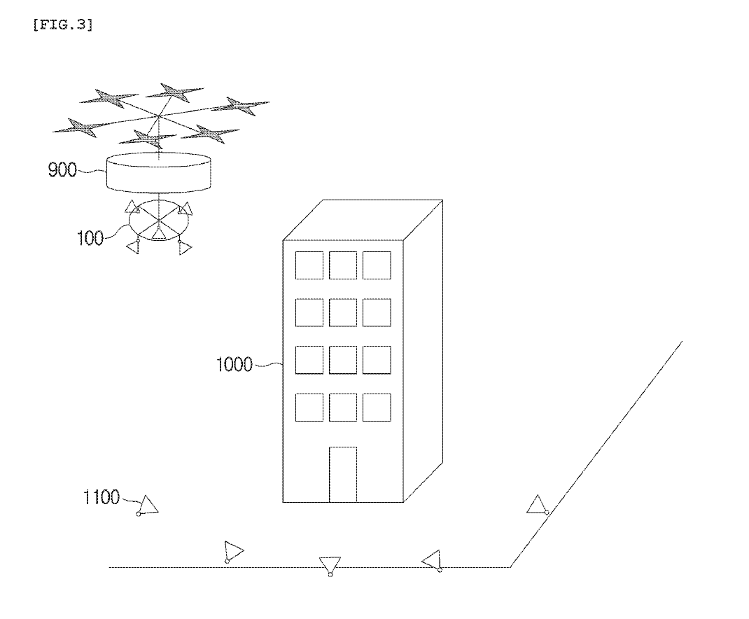

FIG. 3 is a diagram illustrating an example of a system for a multi-camera unmanned device involved in the present invention. Referring to FIG. 3, in order to reconstruct an image of a building 1000 on the ground into a three-dimensional image, there is multiple cameras 300 to 700. For example, the rig 100 provided on the unmanned device 900 may be equipped with the cameras 300 to 600 with the fixed geometric interrelationship. Also, possibly, provided is the independent camera 700 moving on a travel path 701 at the ground around the building 1000. However, the travel path 701 is lust an arbitrarily set path, so that provided is a camera 700 which is completely free to move without a set path.

Also, it is possible that the rig 100 provided on the unmanned device 900 is provided with all the cameras with the fixed geometric interrelationship and the camera with free motion as shown in FIG. 1, and is further provided with another camera with free motion at the ground.

Also, a structure in which a plurality of multi-camera structures is included is also possible. For example, a complex multi-camera structure may be configured in such a manner that a first multi-camera structure is configured to include all cameras with a fixed geometric interrelationship and a camera with free motion for an unmanned device, a second camera structure is configured to include cameras with a fixed geometric interrelationship for another unmanned device, and a third camera structure is configured to include a camera with free motion at the ground.

Accordingly, as described above, various combinations of the cameras with the fixed geometric interrelationship and the camera with free motion are possible. In the meantime, the images obtained in this system are divided, and the geometric interrelationship between the cameras as checked an advance when performing geometric correction, whereby more efficient geometric correction is possible.

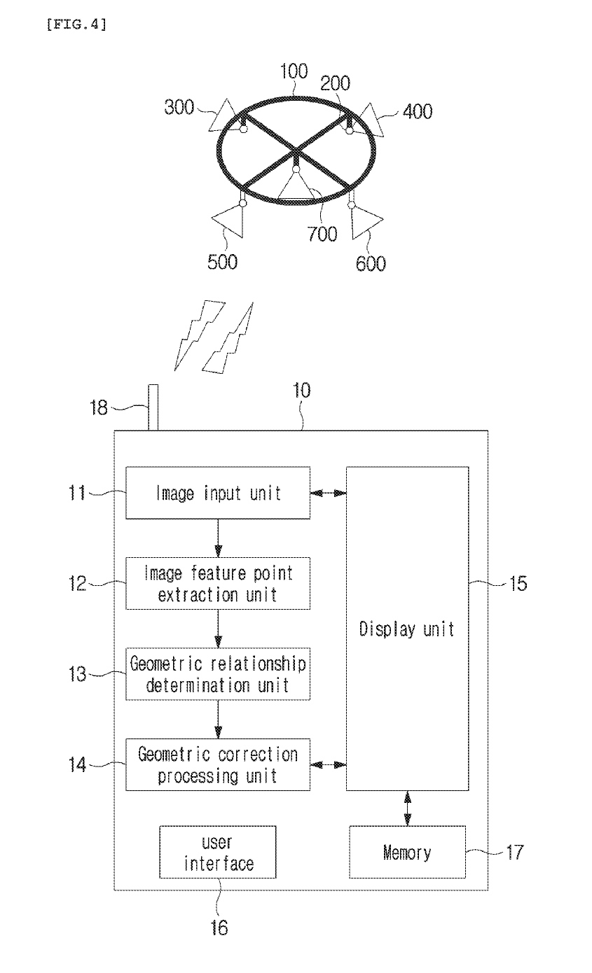

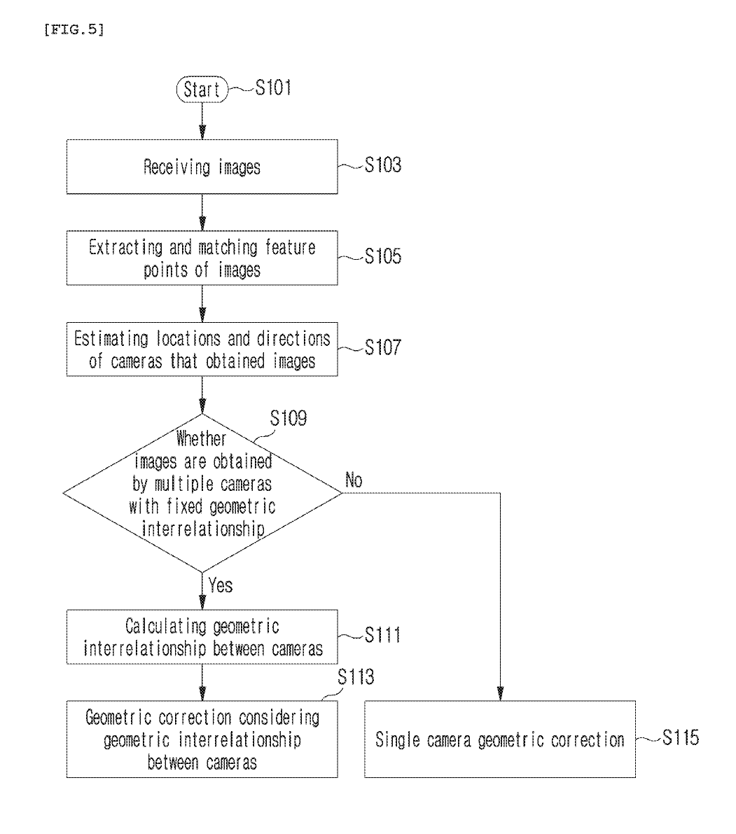

FIG. 4 is a diagram illustrating an example of an image obtainment apparatus for performing geometric correction according to the present invention. FIG. 4 illustrates an example of the image obtainment apparatus 10 separated from the unmanned device 900 equipped with the multiple cameras 300 to 700. However, the concept of the present invention is not limited thereto, and the image obtainment apparatus 10 shown in FIG. 4 may be included within the unmanned device 900.

Referring to FIG. 4, the image obtainment apparatus 10 according to the present invention includes an image input unit 11, an image feature point extraction unit 12, a geometric relationship determination unit 13, and a geometric correction processing unit 14. Also, the image obtainment apparatus 10 according to the present invention further includes: a display unit 15 visually displaying an image that will be or has been subjected to geometric correction; a user interface 16 receiving a user command; a memory 17 storing the image therein; and a communication unit 16 communicating with the camera or an external device. The image input unit 11, the image feature point extraction unit 12, the geometric relationship determination unit 13, and the geometric correction processing unit 14 will be described with reference to a method of performing geometric correction according to an embodiment of the present invention below.

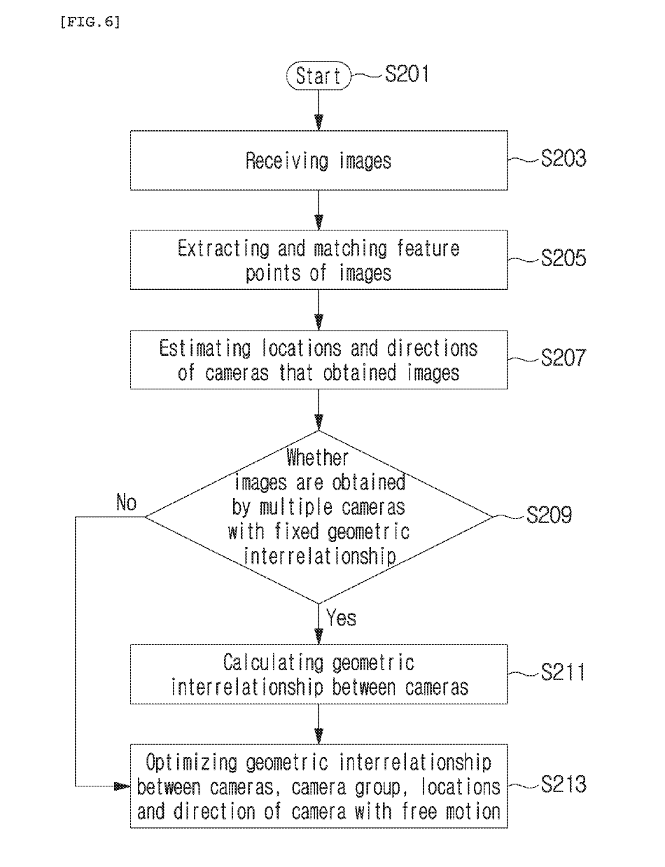

FIG. 5 is a flowchart illustrating a method of performing geometric correction according to an embodiment of the present invention. FIG. 5 is the flowchart illustrating the method of performing geometric correction on images obtained by the unmanned device or the image obtainment apparatus that includes the multiple cameras with the fixed geometric interrelationship and the camera with free motion.

The method of performing geometric correction includes: receiving images at step S103; extracting and matching feature points of the images at step S105; estimating the location and direction of the image at step S107; determining whether the images are obtained by the multiple cameras with the fixed geometric interrelationship at step S109; calculating the geometric interrelationship between the cameras at step S111; optimizing geometric correction by considering the geometric interrelationship between the cameras at step S113; and optimizing geometric correction with respect to the camera with free motion at step S115. In this regard, starting from the step S107 of estimating the location and direction of the image, the steps are performed on every individual input image in principle.

At the step S103 of receiving the images, the image obtained by the camera is received via the image input unit 11. That is, for example, according to the configuration of the system, examples of the method include image transmission with Wi-Fi capable of short-range wireless communication, with wired/wireless data communication, direct copying of a memory card of each camera to the image obtainment apparatus 10, and the like.

Also, at the step S103 of receiving the images, the input images may be classified. For example, the images obtained by the cameras with the fixed geometric interrelationship may be classified using meta information on the images according to the photographing time and the camera used in photographing. In this regard, with respect to the images obtained by the cameras with the fixed geometric interrelationship, the image obtained by one camera of the several cameras is determined as a reference image for each photographing time, and the image obtained by another camera is determined as a comparison image obtained at the same time as the reference image.

At the step S105 of extracting and matching the feature points of the images, the image feature point extraction unit 12 extracts the feature points of the input reference image and comparison image. Moreover, a descriptor that describes the feature point may be extracted. That is, for example, it is possible that the descriptors of the feature points of the reference image and the comparison image are compared to each other and a common relationship is found. Also, using a transition relationship, a feature point correspondence relationship between the reference image and the comparison image or between comparison images may be extended to the correspondence relationship between multiple images.

At the step S107 of estimating the location and direction of the image, the geometric relationship determination unit 13 estimates, with respect to the images in which feature point matching is completed, the location and direction of the camera which obtains each image using information on matching between the feature points. That is, by checking the feature points and the transition relationship between the images obtained by the cameras, it is possible that the locations and directions of the cameras which obtained the images are checked.

At the determination step S109, the geometric relationship determination unit 13 determines whether the images are obtained by the multiple cameras with the fixed geometric interrelationship or by the camera with free motion, using the estimated location and direction of the camera. In this regard, at the determination step S109, it is also possible that whether the images are obtained by the cameras with the fixed relative geometric relationship or by the camera with free motion is determined according to the image classification at the step S103 of receiving the images.

At the step S111 of calculating the geometric interrelationship between the cameras, when determining that the images are obtained by the cameras with the fixed relative geometric relationship, namely, when the result of the determination step S109 is “Yes”, the geometric relationship determination unit 13 calculates the geometric interrelationship between the cameras from the obtained images. Initially, the geometric interrelationship between the cameras is calculated from the estimated locations and directions of the cameras. As the number of processed images increases, processing is performed in such a manner that fine adjustment of the geometric relationship obtained from each image is updated.

At the step S113 of optimizing geometric correction by considering the geometric interrelationship between the cameras, the geometric correction processing unit 14 optimizes geometric correction considering the geometric relationship between the cameras finally calculated at the step S111 of calculating the geometric interrelationship between the cameras. That is, by optimizing the geometric interrelationship between the cameras and the location and direction of the reference image for each time, the number of parameters to be optimized is efficiently reduced, whereby overall computation speed and accuracy are enhanced.

Also, at the step S115 of optimizing geometric correction with respect to the camera with free motion, when determining that the images are not obtained by the cameras with the fixed relative geometric relationship, namely, when the result of the determination step S109 is “No”, it is determined that the images are obtained by the single independent camera, and the geometric correction processing unit 14 optimizes geometric correction from the feature point on the ground surface on which geometric correction is based. For example, the camera with free motion which obtained the image is regarded as a multi-camera system including a single camera which is a reference camera, the number of parameters to be optimized is reduced by self-optimizing the geometric interrelationship between the cameras and the location and direction of the reference image for each time, whereby the speed and accuracy are enhanced.

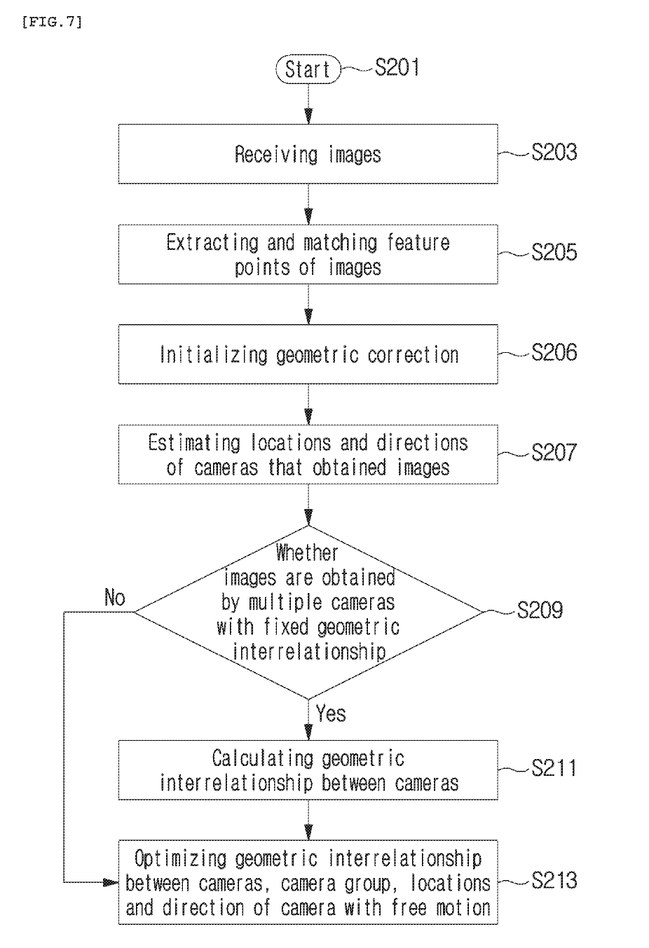

FIG. 6 is a flowchart illustrating a method of performing geometric correction according to another embodiment of the present invention. In this regard, since operations at steps S203, S205, S207, S209, and S211 according to the embodiment shown in FIG. 6 are the same as operations at steps S103, S105, S107, S109, and S111 according to the embodiment shown in FIG. 5, description thereof will be omitted. However, the embodiment shown in FIG. 6 is characterized in that the optimizing of the geometric correction at step S213 is included, which differs from the embodiment shown in FIG. 5.

That is, according to the embodiment shown in FIG. 6, at the step S213 of optimizing geometric correction, optimization is performed on geometric correction simultaneously with respect to all images obtained at the same time, namely, the images obtained at the same time by the cameras with the fixed geometric interrelationship and by the single independent camera with free motion. Also, at the optimizing of geometric correction S213, the geometric interrelationship between the cameras, a camera group, the locations and directions of the camera with free motion are simultaneously optimized. In this regard, “the camera group” means images simultaneously obtained by the multiple cameras with the fixed geometric interrelationship at a particular time.

In the meantime, when the geometric interrelationship between the cameras is known in advance, the step S211 is omitted and the step S213 of optimizing geometric correction is performed without distinction between image input devices.

FIG. 7 is a flowchart illustrating a method of performing geometric correction according to still another embodiment of the present invention. In this regard, the embodiment shown in FIG. 7 is characterized in that the step S206 of initializing geometric correction is added to the embodiment shown in FIG. 6. The remaining steps are denoted by the same reference numerals as in the embodiment shown in FIG. 6.

At the step S206 of initializing geometric correction, the image feature point extraction unit 12 decomposes an essential matrix between the images from initial frame images for initialization and obtains relative positioning and location. After the step S206 of initializing geometric correction, with reference to the calculated relative positioning and location, for each image, a rotation value and a location value of the camera which obtained the image are calculated for each image through a positioning estimation algorithm at the step S207 of estimating the location and direction of the image.

That is, for example, at the step S206 of initializing geometric correction, the essential matrix is decomposed from two initial images, and the geometric relationship between the two images and three-dimensional coordinates the corresponding feature points between the two images are calculated before performing the step S207 on each image. Starting from the successive image, the calculated values are used in calculating the rotation value and the location value of the camera for each image, and then the step S207 of estimating the location and direction of the image is performed.

Also, the step S206 of initializing geometric correction is performed between steps S105 and S107, when being applied to the embodiment shown in FIG. 5, which obviously falls within the scope of the present invention.

As described above, the present invention relates to the image obtainment apparatus including the multiple cameras with the fixed geometric interrelationship and the camera with free motion and the method of performing geometric correction on the images obtained by using the apparatus. The above-described method according to the present invention may be realized as a program and stored in a computer-readable form in a recording medium (for example, a CD-ROM, a RAM, a ROM, a floppy disk, a hard disk, a magneto-optical disk, and the like). Such processes can be easily embodied by those skilled in the art to which the present it belongs, and will not be described in detail.

Various substitutions, modifications, and changes from the spirit of the present invention defined in the following claims by those skilled in the art are also included in the scope of the present invention, so that the present invention described above is not limited to the embodiments and the accompanying drawings.

What is claimed is:

1. A method of performing geometric correction on images obtained by multiple cameras, the method comprising:
receiving, at an image reception step, the images obtained by the multiple cameras;
extracting, at an image feature point extraction step, feature points of the received images and checking an interrelation between the extracted feature points;
estimating, at a location and direction estimation step, locations and directions of the cameras, which respectively obtain the images, by using the interrelation between the feature points;
calculating a relative geometric relationship between the multiple cameras from the estimated locations and directions of the cameras when the received images are determined as the images obtained by the multiple cameras with a fixed geometric interrelationship; and
performing the geometric correction on each of the images by using the calculated geometric relationship.

2. The method of claim 1, further comprising:
performing, when the received images are determined as images obtained by a camera with free motion rather than the multiple cameras with the fixed geometric interrelationship, the geometric correction on each of the images by applying the estimated locations and directions of the camera with free motion.

3. The method of claim 2, wherein the performing of the geometric correction on the images obtained by the multiple cameras with the fixed geometric interrelationship is simultaneous with the performing of the geometric correction on the images obtained by the camera with free motion rather than the multiple cameras with the fixed geometric interrelationship.

4. The method of claim 1, further comprising:
initializing, at a geometric correction initialization step, the geometric correction by using the interrelation between the feature points.

5. The method of claim 4, wherein at the geometric correction initialization step, an essential matrix between the images is decomposed from initial frame images and relative positioning and location values are obtained.

6. The method of claim 1, wherein at the image reception step, the images are received using one among short-range wireless communication means, wired/wireless data communication means, and direct copying from each camera.

7. The method of claim 1, wherein the image reception step comprises:
classifying the images obtained by the cameras with the fixed geometric interrelationship by using meta information on the images.

8. The method of claim 7, wherein the image reception step further comprises:
determining, when the images are classified as the images obtained by the cameras with the fixed geometric interrelationship, the image obtained by one camera of the multiple cameras as a reference image for each photographing time and determining the image obtained by another camera of the multiple cameras as a comparison image obtained at the same time as the reference image.

9. The method of claim 1, wherein at the calculating of the geometric interrelationship between the cameras, the geometric interrelationship between the cameras at a photographing time is estimated from the obtained images.

10. The method of claim 3, wherein at the performing of the geometric correction simultaneously,
simultaneous optimization is performed considering the geometric interrelationship between the cameras, a camera group, and the locations and directions of the camera with free motion.

11. An image obtainment apparatus for performing geometric correction on images obtained by multiple cameras, the apparatus comprising:
an image input unit receiving the images obtained by the cameras;
an image feature point extraction unit extracting feature points of the received images and checking an interrelation between the extracted feature points;
a geometric relationship determination unit estimating locations and directions of the cameras, which respectively obtain the images, by using the interrelation between the feature points, the geometric relationship determination unit calculating a relative geometric relationship between the from multiple cameras the estimated locations and directions of the cameras when the received images are determined as the images obtained by the multiple cameras with a fixed geometric interrelationship; and
a geometric correction processing unit performing the geometric correction on each image by using the calculated geometric relationship.

12. The apparatus of claim 11, further comprising:
a display unit visually displaying an image that will be or has been subjected to the geometric correction.

13. The apparatus of claim 11, further comprising:
a communication unit communicating with the camera or an external device.

14. The apparatus of claim 11, wherein the geometric correction processing unit performs, when the received images are determined as images obtained by a camera with free motion rather than the multiple cameras with the fixed geometric interrelationship, the geometric correction on each of the images by applying the estimated locations and directions of the camera with free motion.

15. The apparatus of claim 14, wherein the geometric correction processing unit simultaneously processes performing of the geometric correction on the images obtained by the multiple cameras with the fixed geometric interrelationship and performing of the geometric correction on the images obtained by the camera with free motion rather than the multiple cameras with the fixed geometric interrelationship.

16. The apparatus of claim 11, wherein the image feature point extraction unit initializes the geometric correction by using the interrelation between the feature points.

17. The apparatus of claim 11, wherein the image input unit classifies the images obtained by the cameras with the fixed geometric interrelationship by using meta information on the images.

18. The apparatus of claim 17, wherein the image input unit determines, when the images are classified as the images obtained by the cameras with the fixed geometric interrelationship, the image obtained by one camera of the multiple cameras as a reference image for each photographing time and determines the image obtained by another camera of the multiple cameras as a comparison image obtained at the same time as the reference image.

19. The apparatus of claim 11, wherein the geometric relationship determination unit estimates the geometric interrelationship between the cameras at a photographing time from the obtained images.

20. The apparatus of claim 15, wherein the geometric correction processing unit performs simultaneously optimization considering the geometric interrelationship between the cameras, a camera group, and the locations and directions of the camera with free motion, in simultaneously processing the performing of the geometric correction.
